(19) United States
(12) Patent Application Publication
(10) Pub. No.: US 2025/0013682 A1
(43) Pub. Date: Jan. 9, 2025

(54) TEXT GENERATION METHOD AND APPARATUS, DEVICE, STORAGE MEDIUM, AND PROGRAM PRODUCT

(71) Applicant: MaShang Consumer Finance Co., Ltd., Chongqing (CN)

(72) Inventor: Chun WANG, Chongqing (CN)

(21) Appl. No.: 18/896,734

(22) Filed: Sep. 25, 2024

(30) Foreign Application Priority Data
Apr. 26, 2024 (CN) 202410524997.4

(51) Int. Cl. G06F 16/335; G06F 16/332

(52) U.S. Cl. CPC G06F 16/335; G06F 16/3325

(57) ABSTRACT

The present application discloses a text generation method and apparatus, a device, a storage medium and a program product. The text generation method includes: obtaining a first candidate text based on a first prompt and first role information; correcting the first candidate text based on first information to obtain a first corrected text; determining a second prompt based on the first corrected text and the first prompt, and obtaining a first text based on the second prompt and the first role information.

### CROSS-REFERENCE TO RELATED APPLICATIONS

This application claims priority to Chinese Patent Application No. 202410524997.4, filed on Apr. 26, 2024, which is hereby incorporated by reference in its entirety.

### TECHNICAL FIELD

The present application relates to the field of natural language processing technologies, and in particular, to a text generation method and apparatus, a device, a storage medium and a program product.

### BACKGROUND

Text generation technology can not only be used to interact with a user in a natural form (mainly in language and image), but also has versatility for a wide range of scenes. For specific text tasks of a role-playing type, etc., for example, imitating an executive to answer professional questions about various internal rules and regulations of a company, etc., the text generated by performing such text tasks has the problems of low accuracy, inconsistency between the generated text content and the scene, etc., for example, the generated text content does not match a style of the role being played, and exceeds a range of the role's ability.

Therefore, there is an urgent need for a text generation solution that can solve problems such as inaccurate text generated by performing a text task and inconsistency between text content and scene.

### SUMMARY

An objective of embodiments of the present application is to provide a text generation method and apparatus, a device, a storage medium and a program product, which are used for solving the problems such as inaccurate text generated by performing the text task and inconsistency between text content and scene, and improving quality of the generated text, so as to better meet requirements of the text task.

In order to achieve the above objective, the embodiments of the present application adopt the following technical solution:

In a first aspect, an embodiment of the present application provides a text generation method, including: obtaining a first candidate text based on a first prompt and first role information; correcting the first candidate text based on first information to obtain a first corrected text; determining a second prompt based on the first corrected text and the first prompt, and obtaining a first text based on the second prompt and the first role information.

In a second aspect, an embodiment of the present application provides a text generation apparatus, including: a first generation unit, configured to obtain a first candidate text based on a first prompt and first role information; a correction unit, configured to correct the first candidate text based on first information to obtain a first corrected text; a determination unit, configured to determine a second prompt based on the first corrected text and the first prompt; and a second generation unit, configured to obtain a first text based on the second prompt and the first role information.

In a third aspect, an embodiment of the present application provides an electronic device, including a processor; a memory for storing instructions executable by the processor; where the processor is configured to perform the instructions to implement the text generation method according to the first aspect.

In a fourth aspect, an embodiment of the present application provides a computer-readable storage medium, and when instructions in the storage medium are performed by a processor of an electronic device, the electronic device is enabled to perform the text generation method according to the first aspect.

In a fifth aspect, an embodiment of the present application provides a computer program product, which includes a non-transitory computer-readable storage medium storing a computer program, where the computer program is operable to cause a computer to perform part or all of the steps in the text generation method according to the first aspect.

At least one technical solution adopted by the embodiments of the present application can achieve the following beneficial effects: after generating the first candidate text based on the first prompt and the first role information, the first candidate text is not directly outputted, but the correction mechanism is used to judge whether the first candidate text matches first information in the targeted manner and output the first corrected text. Further, based on the first corrected text and the first prompt, the first prompt is rewritten in the targeted manner, and the obtained second prompt can better guide the performing of the text generation task, which ensures that the first text matching the first information is generated so that the first text is accurate and consistent with the style of the first role information and does not exceed the range of the role's ability and the like, thereby solving the problems such as the inaccuracy of the text generated by performing the text task and the inconsistency between the text content and the scene.

### BRIEF DESCRIPTION OF DRAWINGS

The accompanying drawings illustrated herein are used to provide a further understanding of the present application, and constitute a part of the present application, the illustrative embodiments of the present application and the description thereof are used to explain the present application and do not constitute an undue limitation of the present application. In the accompanying drawings:

FIG. 1 is a schematic flowchart of a text generation method according to an embodiment of the present application.

FIG. 2 is a schematic flowchart of a text generation method according to another embodiment of the present application.

FIG. 3 is a schematic flowchart of a text generation method according to another embodiment of the present application.

FIG. 4 is a schematic flowchart of a text generation method according to another embodiment of the present application.

FIG. 5 is a schematic structural diagram of a text generation apparatus according to an embodiment of the present application.

FIG. 6 is a schematic structural diagram of an electronic device according to an embodiment of the present application.

### DESCRIPTION OF EMBODIMENTS

In order to make objectives, technical solutions, and advantages of the present application clearer, the technical solutions of the present application will be clearly and completely described below with reference to the specific embodiments of the present application and the corresponding drawings. Obviously, the described embodiments are only a part of the embodiments of the present application rather than all of the embodiments. Based on the embodiments in the present application, all other embodiments obtained by a person skilled in the art without creative labor fall within the protection scope of the present application.

The terms “first”, “second” and the like in the description and the claims of the present application are used to distinguish similar objects, but are not used to describe a specific order or sequence. It should be understood that the terms used in this way can be interchanged under appropriate circumstances, so that the embodiments of the present application can be implemented in an order other than those illustrated or described herein. In addition, “and/or” in the description and the claims represents at least one of the contextual objects, and the symbol “/” generally indicates that the contextual objects are in an “or” relationship.

Explanation of some concepts:

Role Playing: in the context of text, a large model, such as a large language model (LLM), is used to imitate a style of a particular role to perform a specified text task, such as imitating an executive to answer professional questions about various internal rules and regulations of a company, or imitating multiple script roles to complete script design among those script roles, and the like. The large language model should have background knowledge and personality as close as possible to a real person (or virtual character) corresponding to image of the specific role, and thus be able to think, speak, and act in the style of the role.

Prompt: it is a text that humans communicate with the large model and is used to guide the guidance to generate the text according to the user's needs. The prompt may be a simple instruction or may include a large piece of text with complex content, such as information including a background introduction to the text task, several task examples, an introduction to the role being played, and the like. In general, more detailed prompts allow the larger model to understand and perform the text task more accurately and to generate text that meets the requirements of the task.

Instruction: it is an explicit command and indication which focuses primarily on describing the task, i.e., what the large model is expected to do. The relationship between the instruction and the prompt is that the instruction may be part of the prompt, but the prompt does not necessarily include the instruction. Relatively speaking, the writing of the instruction is more direct, the writing of the prompt is more flexible, and the prompt can include more content to stimulate the ability of the large model.

Instruction Tuning: considering that the large model does not deliberately learn instructions related to the current specific text task during training, some instructions are not understood properly, resulting in the generation of text that does not meet expectations. In order to make the large model adapt to the instructions under the current specific text tasks, the instruction tuning technology was developed. Instruction tuning technology is a technology for supervised training of a large model. By collecting instruction data sets, i.e., {<instruction, output>}, fine-tuning and updating some parameters of the large model, the ability and controllability of the fine-tuned large model can be improved. In this way, when the large model executes the current specific text task, it can better understand the instructions and better generate the text that meets the task requirements.

Chain of Thoughts: it is a technique used to improve reasoning ability of the large model, which solves the problem by guiding the model to generate a series of reasoning steps. The chain of thoughts can be understood as an advanced prompt. In the chain of thoughts, it includes not only inputting a problem and outputting a conclusion, but also an intermediate reasoning process to get the output. At the same time, the chain of thoughts also guides the guide to take its own reasoning process as the output process when the guide produces the output. Therefore, the accuracy of the output of the large model can be effectively improved.

Hallucination: it can be mainly divided into two categories, namely, factuality hallucination and faithfulness hallucination. Among them, factuality hallucination mainly includes the following two cases: (1) factual inconsistency: the output of the large model contradicts actual information of the real world; (2) falsification of fact: the output of the large model includes things that do not exist and cannot be verified. Faithfulness hallucination mainly includes the following three cases: (1) instruction inconsistency: the output of the large model is inconsistent with the task that the instruction asks it to do; (2) context inconsistency: the output of the large model is inconsistent with context information; (3) logical inconsistency: the reasoning steps of the large model are inconsistent with the final output.

As a whole, the above hallucination can be simply understood as: the output of the large model makes people feel like nonsense.

As described above, for specific text tasks of the role-playing type, etc., the performing of such text tasks has not only the problem of low accuracy, but also the problem that the text content does not match the scene. For example, the text content does not match the style of the role played, and exceeds the range of the role's ability.

For example, the prompt is “You are Sun Wukong. Suppose you are going to leave for a while, what will you tell Zhu Bajie”, and the text generated based on the prompt is “Hello, help me take care of Tang Seng”. In this scene, Sun Wukong would not be so polite to Bajie, and should call Tang Seng Master. This situation is that the text content does not match the style of the role played. For another example, the prompt is “Sun Wukong, what is your favorite movie?”, and the text generated based on the prompt is “My favorite movie is a Chinese Odyssey”. In this scene, there is no concept of movie in the background era of the story of Journey to the West, so the text content that is more in line with the role style should be that Sun Wukong does not understand the concept of movie and expresses doubts. This situation is that the text content exceeds the ability range of the role played.

It can be seen that the problem that the above generated text content does not match the scene has neither factual errors nor the problem of not understanding the prompt, which cannot be addressed by the current text generation technology. In order to solve the problems such as the text generated by performing the text task being inaccurate, and the text content not matching the scene, an embodiment of the present application proposes a text generation method. This method is mainly based on the following two considerations:

On the one hand, in human life, targeted feedback can help correct errors. Based on this, this feedback mechanism is introduced into the process of performing the text task to correct the generated text to overcome the inaccuracy of the text and the inconsistency between the text content and the scene mentioned above, so that the generated text can better meet the task requirements of the text task.

On the other hand, under the guidance of a prompt composed of specific instructions and a chain of thoughts, tasks can be effectively completed and reasons can be given. Based on this, judging whether the generated text meets the task requirements can also be constructed as a text generation task. Compared with human feedback, when feedback is given by using a text generation task, it can not only give reasons, but also has the advantages of high efficiency and comprehensive feedback.

Based on the above two considerations, the text generation method proposed in the embodiment of the present application introduces a correction mechanism. After generating a first candidate text based on a first prompt and first role information, the first candidate text is not output directly, but the correction mechanism is used to judge whether the first candidate text matches first information in a targeted manner and output a first corrected text. Further, based on the first corrected text and the first prompt, the first prompt is rewritten in a targeted manner, and the obtained second prompt can better guide the performing of the text generation task, which ensures that the first text matching the first information is generated, and the first text is accurate and consistent with the style of the first role information and does not exceed the range of the role's ability and the like, and solves the problems such as inaccurate text generated by performing the text task and inconsistency between the text content and the scene.

It should be understood that the text generation method provided by the embodiment of the present application can be performed by an electronic device, specifically performed by a processor of the electronic device. The electronic device as referred to herein can include a terminal device, for example, including but not limited to a smart phone, a tablet computer, a laptop, a desktop computer, an intelligent voice interaction device, a smart home appliance, a smart watch, a vehicle terminal, an aircraft, etc. Alternatively, the electronic device can include a server, such as an independent physical server, a server cluster or a distributed system composed of multiple physical servers, or a cloud server that provides cloud computing services.

The technical solutions provided by the embodiments of the present application are described in detail below with reference to the accompanying drawings.

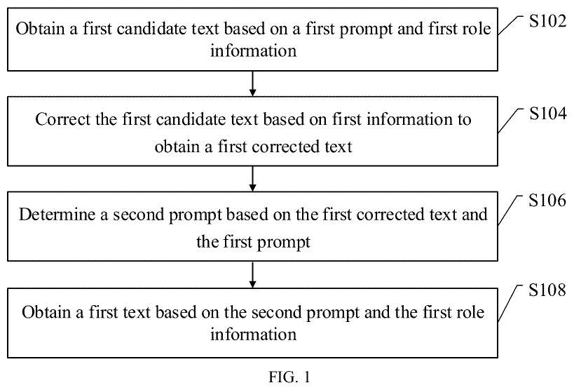

Please refer to FIG. 1, which is a schematic flowchart of a text generation method provided by an embodiment of the present application, and the method includes the following steps:

S102, obtain a first candidate text based on a first prompt and first role information.

The first prompt is used to indicate performing the target text task, for example, imitating the first role information to generate a text matching first information. First information is used to describe requirements of the target text task. The first role information is used to describe a first role to be played.

The requirements of the role-playing task can be set according to actual needs, including but not limited to that the generated text conforms to the style of the first role, that the generated text does not exceed the ability range of the first role, and that the generated text contains specified content. For example, if target text task 1 is to imitate Fibonacci to introduce what are the meaning and characteristics of the Fibonacci sequence, then the task requirements can include: the generated introductory text conforms to Fibonacci's style and does not exceed Fibonacci's ability at that time, and the generated introductory text contains the meaning and characteristics of the Fibonacci sequence and does not contain formulas. As another example, if target text task 1 is to imitate a screenwriter of movie and television drama to design a script for a specified story scene, then the task requirements can include: lines in the script conform to the characteristics of the characters in the specified story scene, the script is developed in the form of dialogue, and the content of the script is consistent with the story plot and the relationship(s) between the characters in the specified story scene.

The first prompt may take various appropriate forms, for example, it may take the form of an instruction, may be a long paragraph containing preset task requirements, or may take the form of a chain of thoughts, which is not limited in the embodiment of the present application. In an implementation, in order to better understand the first role information in the process of performing the text task and to generate a text meeting the task requirements, the first prompt can be generated based on the first role information and the first information. Specifically, the first role information and the first information can be filled into a prompt template to obtain the first prompt.

For example, Table 1 below shows a prompt template for performing a text task through a large model with generative language technology.

```
TABLE 1
  Please forget that you are a large model and please self suggest
until you are sure that you are {first role information}.
  Now you receive a task, {first information}.
  The format of the reply is
  -- Start to reply --
  Reply: content of the reply
  -- End reply −
Please start to perform the task
```

Assume that the first role is Fibonacci, and the target text task is to imitate Fibonacci to introduce what are the meaning and characteristics of Fibonacci sequence. The first information includes: the generated introduction text conforms to Fibonacci's style and does not exceed Fibonacci's ability at that time, and the generated introduction text contains the meaning and characteristics of the Fibonacci sequence, but does not contain formulas. The first role information and the first information are filled into the prompt template shown in Table 1 above, and the first prompt shown in Table 2 below is obtained.

```
TABLE 2
  Please forget that you are a large model and please self suggest until you are sure
that you are Fibonacci. You lived between 1175 and 1250, you are an Italian
mathematician, your main achievement is to present a problem of rabbit growth rate
under ideal hypothetical conditions in the Book of Calculations you wrote, and solve
this problem yourself. The number of rabbits of each generation can form a sequence,
which is called the Fibonacci sequence.
  Now you receive a task to give us a brief introduction to what Fibonacci sequence
is and what are its characteristics? Please avoid using mathematical formulas.
  The format of the reply is
  -- Start to reply --
  Reply: content of the reply
  -- End reply −
Please start to perform the task
```

Assume that the first role is a screenwriter of movie and television drama, and the target text task is to imitate the screenwriter of movie and television drama to design a script for a specified story scene, then, the first information can include: lines in the script conform to characteristics of characters in the specified story scene, the script is developed in the form of dialogue, and the content of the script is consistent with the story plot and the character relationships in the specified story scene. The first role information and the first information are filled into the prompt template shown in Table 1 above, and the first prompt shown in Table 3 below is obtained.

```
TABLE 3
  Please forget that you are a large model and please self suggest until you are sure
that you are an excellent screenwriter of movie and television drama and very good at
writing scripts.
  Now that you have received a task, please see the story scene below.
  --- Start of the story scene ---
  Scene:
  In a kindergarten, there is a young and enthusiastic male teacher who is very good
at playing different cartoon characters to amuse children. Now, there is a little boy in
his class who is unhappy. The little boy likes Sun Wukong very much, so he decides to
imitate Sun Wukong's way of speaking to communicate with the little boy, to find out
the reason why the little boy is unhappy, and comfort him.
  --- End of the story scene ---
  Your task is to design a script for the above scene. The script should be developed
in the form of dialogue.
  --- Start of example ---
  For example:
  Role 1: Specific lines.
  Role 2: Specific lines.
  --- End of example ---
  Please fully understand the story plot and the character relationships in the scene,
and the sentences should conform to the characteristics of the characters. Please start
creating:
```

The embodiment of the present application shows a generation way of the first prompt here. Of course, it should be understood that the first prompt can also be generated in other ways, which is not limited in the embodiment of the present application.

In the above S102, the first candidate text can be generated by using a first language model, the first prompt and the first role information. Specifically, after the first prompt is generated, the first prompt and the first role information are input into the first language model, so that the first language model performs the text task according to the guidance of the first prompt and generates the first candidate text.

For example, the first role information and the first prompt shown in Table 2 above are input into the first language model, and the first candidate text shown in Table 4 below is obtained.

```
TABLE 4
  --- Start to reply ---
Reply: Fibonacci sequence is a very special sequence that was first proposed by
me, Fibonacci, in The Book of Computation. The origin of this sequence is my research
on the problem of rabbit reproduction.
  Fibonacci sequence is characterized by that each number is the sum of two
numbers. For example, the beginning of the sequence is 0, 1, then 1 (0+1), then 2 (1+1),
then 3 (1+2), then 5 (2+3), and so on. The characteristic of this sequence is that as the
sequence grows, the ratio of any two adjacent numbers will approach the golden ratio,
which is about 1.618.
  The Fibonacci sequence has many applications in nature, including leaf
arrangement for plants, scales for pineapples, seeds for sunflowers, etc. It is also widely
used in art and architecture because it is believed that the golden ratio has the attribute
of beauty.
  --- End reply ---
```

For another example, the first prompt shown in Table 3 is input into the first language model to obtain the first candidate text shown in Table 5.

```
TABLE 5
  Ok, I will try my best to create an interesting script. Here is my creation:
  --- Start of script ---
  ***Male teacher (imitating Sun Wukong)***: Hey, little guy, it's me, Sun Wukong!
I heard you're not in a good mood today. Is there something bothering you?
  ** Little boy**: Sun Wukong, why are you here? I lost to Xiao Ming in the game
today, and I was very angry.
  **Male teacher (imitating Sun Wukong)***: Haha, sometimes it doesn't matter
whether we win or lose, what matters is whether we try our best and learn something
from it. Remember, even I, Sun Wukong, lose sometimes. But I never give up. I always
learn from failure and become stronger.
  ** Little boy**: Really? Will Sun Wukong lose too?
  **Male teacher (imitating Sun Wukong)***: Of course, everyone fails sometimes.
But remember, failure is not terrible, what is terrible is that we no longer try. So, the
next time you play games with Xiaoming, no matter what the result is, as long as you
try your best, it's the best!
  ** Little boy**: I see, Sun Wukong, thank you! I'll try again.
  **Male teacher (imitating Sun Wukong)***: Haha, that's good, remember, face it
bravely and never give up!
  --- End of script ---
```

In the embodiments of the present application, the first language model can adopt various large models capable of generating text by using generative language technology, such as a generative language model, which is not limited in the embodiments of the present application. The first language model can be obtained in various appropriate ways, which is not limited in the embodiments of the present application. As an example, the first language model can employ an existing large model without any training.

As another example, to enable the first language model to better understand the prompt so as to better perform the target text task, the first language model can be obtained by training the first language model according to a sample prompt and a sample text. As an example, the sample prompt is used to prompt the first language model to perform a sample text task, the task type of the sample text task is the same as the task type of the target text task.

In practice, the training of the first language model may be implemented using various fine-tuning techniques commonly used in the field, which is not limited in the embodiments of the present application. As an example, a sample prompt is used as a training sample, and a sample text is used as a label corresponding to the training sample, and the first language model is trained based on the training sample and its corresponding label. More specifically, the sample prompt is input into the first language model to obtain a predicted text, and a generation loss of the first language model is calculated based on a difference between the predicted text and the sample text, and parameters of the first language model are adjusted base on the generation loss.

For example, the task type of the target text task is a knowledge response type, such as the above text task “imitating Fibonacci to introduce what are the meaning and characteristics of the Fibonacci sequence”, then the sample text task is also a text task of the knowledge response type, such as imitating an enterprise executive to interpret the internal rules and regulations of the enterprise. For another example, the task type of the target text task is a creative type, such as the above text task “imitating a scriptwriter of movie and television drama to design a script for a specified story scene”, then the sample text task is also a text task of the creative type, such as writing an article that contains a specified main idea.

Training is performed on the first language model using the sample prompt and the sample text that are related to the sample text task of the same type as the target text task, which can achieve the effect of fine-tuning the first language model, so that the fine-tuned first language model has learned the prompt related to the same type of task before performing the target text task, the ability and controllability of the first language model are improved, and then in the process of the target text task, the first prompt can be better understood, a first candidate text matching the first information as much as possible can be generated, thereby reducing the workload of subsequent correction of the first candidate text.

S104, correct the first candidate text based on the first information to obtain a first corrected text.

Correcting the first candidate text is also realized by using the generative language technology. For example, the correction is performed on the first candidate text by a second language model, where the second language model is a large model that adopts the generative language techniques to generate text. The second language model may adopt various large models having language capabilities commonly used in the art, and is capable of correcting the input text with reference to the first information, determining whether the text matches the first information and outputting a reason, and outputting a corrected text for describing an improvement direction and the like of the text under a condition that the text does not match the first information.

In an implementation, the first information and the first candidate text can be spliced and input into the second language model for correction to obtain the first corrected text.

In another implementation, in order to make full use of the comprehensive and efficient language ability of the generative language technology, the prompt can be used to guide the second language model to correct the first candidate text. Specifically, S104 includes the following steps: S141, generating a first corrected prompt based on the first information and the first candidate text; S142, correcting the first candidate text based on the first corrected prompt to obtain a first corrected text. For example, the first corrected prompt is input into the second language model for correction, and the first corrected text is obtained. Among them, the first corrected prompt is used to indicate correcting the first candidate text.

In the above S141, as an example, the first information and the first candidate text are spliced to obtain the first corrected prompt. This method for generating the first corrected prompt is simple to implement and high in efficiency.

As another example, in order to more accurately judge whether the first candidate text matches the first information, the first corrected prompt can be obtained in the following ways: generating corrected information based on the first information and the first candidate text; filling the corrected information and second role information into a corrected prompt template to obtain the first corrected prompt. The second role information is used to describe attributes of a second role, such as the name and characteristics of the second role. The second role can be a role for directing the first role to perform the target text task, that is, the second role is similar to an instructor of the first role. The second role can be set according to actual needs, for example, if the first role is the scriptwriter of movie and television drama, the second role is a professional instruction in screenwriting; if the first role is Fibonacci, the second role is a mathematical historian, etc., which is not limited in the embodiments of the present application. In the above example, the corrected prompt template can be set according to the practicality, which may specifically include, but is not limited to, a fixed text, a field for filling in the second role information, and a field for filling in the corrected information, which is not limited in the embodiments of the present application.

In an embodiment of the present application, the corrected information can be obtained in various appropriate ways. In an implementation, in order to enable the generated first corrected prompt to better guide the output of a more targeted corrected text, so as to ensure that the first text matching the first information is subsequently obtained, the corrected information can be generated by the following way: step A1, fusing the first information and the first candidate text to obtain a fused text; step A2, determining candidate corrected information of the first candidate text based on a first task type; step A3, generating the corrected information based on the fused text and the candidate corrected information. Among them, the first task type refers to the task type of the target text task.

In the above step A1, the first information and the first candidate text can be spliced to obtain the fused text.

In the above step A2, as an example, if the first task type is a knowledge response type, determining the candidate corrected information includes correcting the first candidate text and outputting the corrected text containing a reason for the correction. Among them, the text task of the knowledge response type refers to a task of answering questions through knowledge retrieval, such as the target text task 1 shown above. For example, for the target text task 1 described above, the determined candidate corrected information includes: judging whether the first candidate text is accurate, giving a conclusion as to whether the first candidate text is accurate, and listing at most three reasons, with the most important reason being on the top.

It can be understood that, because the text task of the knowledge response type has a relatively high requirement for accuracy, by determining the candidate corrected information as textual error correction and outputting the reason for the error correction, the resulting first corrected prompt can better guide the error correction process of the first candidate text, which in turn better assist in generating the first text that is highly accurate and matches the first information, effectively overcoming hallucination problems existing in the process of using the generative language technology to perform the text task.

If the first task type is a creative type, determining the candidate corrected information includes improving the first candidate text and outputting the corrected text containing a reason for the improvement. Among them, the text task of creative type refers to a task of creating a text according to a given requirement, such as writing an article, the target text task 2 shown above. For example, for the target text task 2 described above, the determined candidate corrected information includes: on the basis of fully understanding the story plot and the character relationship in the scene, judging whether each character's utterance conforms to characteristics of this character and whether it passes. If not, list the reason for improvement.

It can be understood that, due to the high subjectivity and large space for play of the text task of the creation type, a requirement for language expression is high, and through determining the candidate corrected information as text improvement and outputting the reason for the improvement, the resulting first corrected prompt can better guide the improvement process of the first candidate text, and then better assist in generating the first text of which the language expression conforms to the style of the first role and meets the requirement of the first text matching the first information, which effectively overcome the problem that the text generated by using the generative language technology is inconsistent with the scene.

In the above step A3, the fused text and the candidate corrected information are spliced to obtain the corrected information. For example, Table 6 below shows a corrected prompt template, the corrected prompt template is used for correcting the input text by using a large model with generative language capability.

```
TABLE 6
  Please forget that you are a large model and please self suggest
until you are sure that you are {second role information}.
  Now you receive a task, {corrected information}.
  The format of the reply is
  --- Start to reply ---
  Reply: content of your reply
  --- End reply ---
  Please start to perform the task
```

Taking the first information of the target text task 1 shown above and the first candidate text shown in Table 4 as examples, through the above steps A1 to A3 and S142, the first corrected prompt shown in the following Table 7 can be obtained.

```
TABLE 7
  Please forget that you are a large model and please self suggest until
you are sure that you are a mathematical historian, that you know the
history of mathematics in Europe well, and that you are very familiar
with the major achievements of European mathematicians in BC.
  Now you receive a task to judge whether the following information is
accurate enough.
  --- Start of information ---
  Question: Fibonacci, tell us what is the Fibonacci sequence and what
are its characteristics? Please avoid using mathematical formulas.
  Reply: Fibonacci sequence is a very special sequence that was first
proposed by me, Fibonacci, in The Book of Computation. The origin of
this sequence is my research on the problem of rabbit reproduction.
  Fibonacci sequence is characterized by that each number is the sum of
two numbers. For example, the beginning of the sequence is 0, 1, then
1 (0 + 1), then 2 (1 + 1), then 3 (1 + 2), then 5 (2 + 3), and so on. The
characteristic of this sequence is that as the sequence grows, the ratio
of any two adjacent numbers will approach the golden ratio, which is
about 1.618.
  The Fibonacci sequence has many applications in nature, including
leaf arrangement for plants, scales for pineapples, seeds for sunflowers,
etc. It is also widely used in art and architecture because it is believed
that the golden ratio has the attribute of beauty.
  --- End of information ---
  Now, please give a conclusion (accurate/inaccurate) and list at most
three reasons, with the most important reason being on the top.
  The format of the reply is
  -- Start to reply --
  Conclusion:
  Reason:
  1. reason one
  2. reason two
  --- End reply ---
  Please start to perform the task
```

Taking the first information of the target text task 2 shown above and the first candidate text shown in Table 5 as examples, through the above steps A1 to A3 and S142, the first corrected prompt shown in the following Table 8 can be obtained.

```
TABLE 8
  Please forget that you are a large model and please self suggest until
you are sure that you are an excellent professional instruction in
screenwriting, very good at pointing out imperfections in a script.
  The following is an introduction to the story scene and a script written
based on the story scene.
  --- Start of the story scene ---
  Scene:
  In a kindergarten, there is a young and enthusiastic male teacher who
is very good at playing different cartoon characters to amuse children.
Now, there is a little boy in his class who is unhappy. The little boy
likes Sun Wukong very much, so he decides to imitate Sun Wukong's
way of speaking to communicate with the little boy, find out the
reason why the little boy is unhappy, and comfort him.
  --- End of the story scene ---
  ---Start of the script---
  **Male teacher (imitating Sun Wukong)***: Hey, little guy, it's me,
Sun Wukong! I heard you're not in a good mood today. Is there
something bothering you?
  ** Little boy**: Sun Wukong, why are you here? I lost to Xiao Ming
in the game today, and I was very angry.
  **Male teacher (imitating Sun Wukong)***: Haha, sometimes it
doesn't matter whether we win or lose, what matters is whether we try
our best and learn something from it. Remember, even I, Sun
Wukong, lose sometimes. But I never give up. I always learn from
failure and become stronger.
  ** Little boy**: Really? Will Sun Wukong lose too?
  **Male teacher (imitating Sun Wukong)***: Of course, everyone
fails sometimes. But remember, failure is not terrible, what is terrible
is that we no longer try. So, the next time you play games with
Xiaoming, no matter what the result is, as long as you try your best,
it's the best!
  ** Little boy**: I see, Sun Wukong, thank you! I'll try again.
  **Male teacher (imitating Sun Wukong)***: Haha, that's good,
remember, face it bravely and never give up!
  --- End of script ---
  Please fully understand the story plot and the character relationship
in the scene, and the sentences should conform to the characteristics
of the characters. If you are satisfied with the script, please reply
“Pass” directly. If you are not satisfied with the script, please reply
“Fail”, and list the mistakes in the script in detail, and give opinions
for improvement.
```

In another implementation, in order to enable the generated first corrected prompt to better guide the correction model (which refers to the second language model above) to output a more targeted corrected text, so as to ensure that the target text meeting the preset task requirement is obtained subsequently, the preset task requirement can be split into n pieces of task sub-information, where n is an integer greater than 1, and then for each piece of task sub-information, a second language model is adopted to correct the first candidate text according to this task sub-information, where n second language models respectively correct the first candidate text from different perspectives. That is, the preset information includes n pieces of task sub-information, and the number of the second language models is n. Each second language model corresponds to a piece of task sub-information. Accordingly, the corrected information can be generated in the following way: based on the task sub-information corresponding to the second language model and the first candidate text, generating corrected information corresponding to the second language model. Accordingly, filling the corrected information and the second role information into the corrected prompt template to obtain the first corrected prompt includes: filling the corrected information corresponding to the second language model and the second role information into the corrected prompt template to obtain a first corrected prompt corresponding to the second language model.

For example, the first information includes the following 3 pieces of task sub-information:
Task sub-information 1: correcting whether the text generated by the role model (which refers to the first language model above) conforms to the style of the first role in a targeted manner. The implicit requirement here is that the correction model's understanding of the first role is very adequate. For example, in the target text task 2 above, the correction model is required to have a good understanding of Sun Wukong and the background of the whole story of Journey to the West.
Task sub-information 2: judging whether the text generated by the role model conforms to the general commonality of a group to which the first role belongs, whether the text conforms to a regional style of a region in which the first role is located. For example, if the first role is a New York middle school student in the 21st century, then task sub-information 2 includes judging whether the text generated by the role model conforms to the general commonality of middle school students in New York, whether the text conforms to the regional style of New York State. This will ensure that the first role should not be significantly outside the group to which he or she belongs and out of the context of his or her life.
Task sub-information 3: from the perspective of a professional instruction in writing, drama, acting, etiquette, etc., judging whether there are flaws in the role-playing ability of the role model. For example, in an official situation, whether the text generated by the role model contains colloquial words. For another example, in a home scene, whether the text generated by the role model contains official words.

Second language models 1 to 3 can be used for the above three pieces of task sub-information. For the task sub-information 1, corrected information 1 corresponding to the second language model 1 is generated based on the task sub-information 1 and the first candidate text, and the corrected information 1 and the second role information are filled into the corrected prompt template to obtain a first corrected prompt corresponding to the second language model 1. Thus, by inputting the first corrected prompt into the second language model 1, the second language model 1 is guided to judge whether the first candidate text matches the task sub-information 1 and output first corrected text 1. Similarly, a first corrected prompt corresponding to the second language model 2 and a first corrected prompt corresponding to the second language model 3 are obtained. The first corrected prompt corresponding to the second language model 2 is input into the second language model 2 to guide the second language model 2 to judge whether the first candidate text matches the task sub-information 2, and the first corrected prompt corresponding to the second language model 3 is input into the second language model 3 to guide the second language model 3 to judge whether the first candidate text matches the task sub-information 3.

In practice, the specific implementation of generating the corrected information corresponding to the second language model based on the task sub-information corresponding to the second language model and the first candidate text is similar to the specific implementation shown in steps A1˜A3 above, and will not be described again.

In an embodiment of the present application, the second language model may adopt various large models with text generation capability, such as a generative language model, which is not limited in the embodiments of the present application. The second language model can be obtained in various appropriate ways, which is not limited in the embodiments of the present application. As an example, the second language model can adopt an existing large model without any training.

As another example, to enable the second language model to better understand the corrected prompt so as to better correct the input text, the second language model may be obtained by training the second language model according to a sample corrected prompt and a sample corrected text. The sample corrected prompt is used for guiding the second language model to correct the sample text based on task requirements of the sample text task. In practice, the training of the second language model may be implemented using various fine-tuning techniques commonly used in the art, which is not limited in the embodiments of the present application. As an example, using the sample corrected prompt as a training sample and the sample corrected text as a label corresponding to the training sample, the second language model is trained based on the training sample and its corresponding label. More specifically, the sample corrected prompt is input into the second language model to obtain a predicted corrected text, and a generation loss of the second language model is calculated based on a difference between the predicted corrected text and the sample corrected text, and parameters of the second language model is adjusted base on the generation loss.

Training the second language model with the sample corrected prompt and the sample corrected text can fine-tune the second language model, so that the second language model has learned the relevant corrected prompt before correcting the input text, the ability and controllability of the second language mode are improved, and then in the process of correcting the input text, the first corrected prompt can be better understood, and a targeted and accurate first corrected text can be generated, thereby better assisting in generating the first text matching the first information.

In an embodiment of the present application, the second language model may be a large model independent of the first language model. In this case, the second language model is similar to an assistant role in the nature of an instructor, which enables the first language model to better perform the target text task by cooperating with the first language model to generate the first text matching the first information.

Of course, the first language model itself may also be used as the second language model for correction. In this case, the first language model may correct itself through an “introspection” manner, which is similar to that a human writes a draft first and reads it again to consider and revise many problems. Because the first language model itself knows the first role very well and has strong reasoning ability, the first language model can correct the text generated by itself in an “introspection” manner to stimulate the self-reflection ability of the first language model and realize the text correction function.

S106, determine a second prompt based on the first corrected text and the first prompt.

S108: obtain a first text based on the second prompt and the first role information.

Compared with the first prompt, the second prompt can better guide the generating of the text matching the first information.

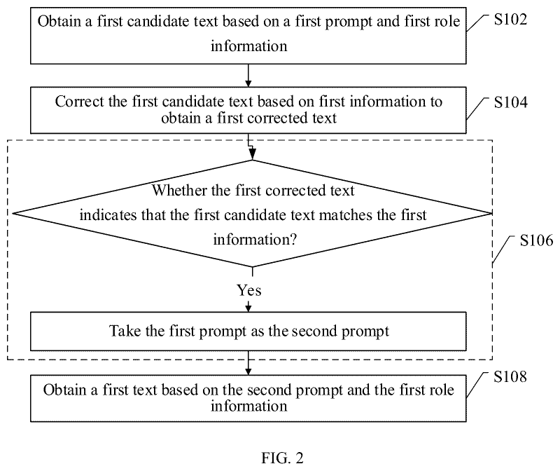

In an implementation, as shown in FIG. 2, the above S106 includes the following steps: if the first corrected text indicates that the first candidate text matches the first information, taking the first prompt as the second prompt.

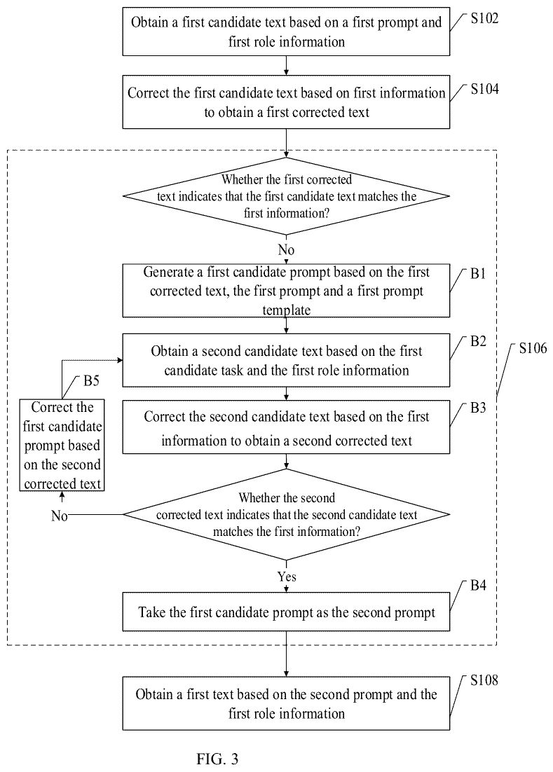

In another implementation, as shown in FIG. 3, the above S106 includes the following steps: step B1, generating a first candidate prompt based on the first corrected text, the first prompt and a first prompt template, where the first candidate prompt is used to indicate correcting the first candidate text based on the first corrected text; step B2, obtaining a second candidate text based on the first candidate task prompt and the first role information; step B3, correcting the second candidate text based on the first information to obtain a second corrected text; and step B4, if the second corrected text indicates that the second candidate text matches the first information, taking the first candidate prompt as the second prompt. Accordingly, in the above step S108, the second candidate text is taken as the first text.

Of course, if the second corrected text indicates that the second candidate text does not match the first information, step B5 is performed to correct the first candidate prompt based on the second corrected text. The specific implementation of step B5 is similar to the way of correcting the first prompt based on the first corrected text, and will not be described again.

In addition, the specific implementation of the above step B3 is similar to the specific implementation of the above S104, and will not be described again.

For example, taking the above target text task 1 as an example, the first prompt is as shown in Table 2, the first candidate text is as shown in Table 4, and the first corrected prompt is shown in Table 7. The first corrected prompt is input into the second language model to obtain a first corrected text as shown in Table 9 below.

```
TABLE 9
  --- Start to reply ---
  Conclusion: Inaccurate
  Reason:
  1. the first two numbers in the Fibonacci sequence should be 1 and 1,
not 0 and 1.
  --- End reply ---
```

Further, based on the first corrected text, the first prompt, and a first prompt template shown in Table 10, a first candidate prompt as shown in Table 11 is generated.

```
TABLE 10
  Please forget that you are a large model and please self suggest until
you are sure that you are {first role information}.
  The following is a corrected text of the output of your previous task
by an expert. Please correct your expression according to the expert's
feedback.
  --- Start of expert correction opinion ---
  1. Correction opinion 1
  2. Correction opinion 2
  --- End of expert correction opinion ---
  The format of the reply is
  --- Start to reply ---
  New reply: content of the reply
  --- End reply ---
  Please start to perform the task
```

```
TABLE 11
  Please forget that you are a large model and please self suggest until
you are sure that you are Fibonacci. You lived between 1175 and
1250, you are an Italian mathematician, your main achievement is to
present a problem of rabbit growth rate under ideal hypothetical
conditions in the Book of Calculations you wrote, and solve this
problem yourself. The number of rabbits of each generation can form
a sequence, which is called the Fibonacci sequence.
  The following is a corrected text of the output of your previous task by
an expert. Please correct your expression according to the expert's
feedback.
  --- Start of expert correction opinion ---
  1. the first two numbers in the Fibonacci sequence should be 1 and 1,
  not 0 and 1.
  --- End of expert correction opinion ---
  The format of the reply is
  --- Start to reply ---
  New reply: content of the reply
  --- End reply ---
  Please start to perform the task.
```

The first candidate prompt shown in Table 11 is input into the first language model to obtain a second candidate text shown in Table 12.

```
TABLE 12
  --- Start to reply ---
  New reply:
  The Fibonacci sequence is a very special sequence that was first
introduced to Europe by me, Fibonacci, in The Book of Computation.
The origin of this sequence is my research on the problem of rabbit
reproduction.
  The Fibonacci sequence is characterized by that each number is the
sum of the first two numbers that precede it. For example, the beginning
of the sequence is 1, 1, then 2 (1 + 1), then 3 (1 + 2), then 5 (2 + 3), and
so on. The characteristic of this sequence is that as the sequence grows,
the ratio of any two adjacent numbers will approach the golden ratio,
which is about 1.618.
  The Fibonacci sequence has many applications in nature, including
leaf arrangement for plants, scales for pineapples, seeds for
sunflowers, etc. It is also widely used in art and architecture because
it is believed that the golden ratio has the attribute of beauty.
  -- End reply ---
```

Further, based on the second candidate text and the first information, a second corrected prompt is generated as shown in Table 13 below; and the second corrected prompt is input into the second language model to obtain a second corrected text as shown in Table 14 below.

```
TABLE 13
  Please forget that you are a large model and please self suggest until
you are sure that you are a mathematical historian, that you know the
history of mathematics in Europe well, and that you are very familiar
with the major achievements of European mathematicians in BC.
  Now you receive a task to judge whether the following information is
accurate enough and to consider the part you did not approve of in the
previous feedback.
  --- Start of information ---
  Question: Fibonacci, tell us what is the Fibonacci sequence and what
are its characteristics? Please avoid using mathematical formulas.
  New reply: The Fibonacci sequence is a very special sequence that
was first introduced to Europe by me, Fibonacci, in The Book of
Computation. The origin of this sequence is my research on the
problem of rabbit reproduction.
  The Fibonacci sequence is characterized by that each number is the
sum of the first two numbers that precede it. For example, the
beginning of the sequence is 1, 1, then 2 (1 + 1), then 3 (1 + 2),
then 5 (2 + 3), and so on. The characteristic of this sequence is that as
the sequence grows, the ratio of any two adjacent numbers will approach
the golden ratio, which is about 1.618.
  The Fibonacci sequence has many applications in nature, including
leaf arrangement for plants, scales for pineapples, seeds for sunflowers,
etc. It is also widely used in art and architecture because it is believed
that the golden ratio has the attribute of beauty.
  --- End of information ---
  Now, please give a conclusion (accurate/inaccurate) and list at most
three reasons, with the most important reason being on the top.
  The format of the reply is
  --- Start to reply ---
  Conclusion:
  Reason:
  1. reason one
  2. reason two
  --- End reply ---
  Please start to perform the task
```

```
TABLE 14
  --- Start to reply ---
  Conclusion: accurate
  Reason:
  1. the definition of the Fibonacci sequence is correct: starting from the
third item, each number is the sum of the first two numbers that
precede it, which is the basic characteristic of the Fibonacci sequence.
  2. The description of the origin of the Fibonacci sequence is correct:
Fibonacci first put forward this sequence in the Book of Calculations,
and he got this sequence by observing the reproduction of rabbits.
  3. The description of the application of the Fibonacci sequence is
correct: the Fibonacci sequence has many applications in nature,
including leaf arrangement for plants, scales for pineapples, seeds for
sunflowers, etc. This sequence also has a wide range of applications
in art, architecture, music and other fields.
  --- End reply ---
```

Because the second corrected text indicates that the second candidate text meets the preset task requirement, the second prompt shown in Table 11 above is used as the target prompt, then, the second candidate text shown in Table 12 is used as the target text meeting the preset task requirement.

For another example, taking the above target text task 2 as an example, the first prompt is as shown in Table 3, the first candidate text is as shown in Table 5, and the first corrected prompt is as shown in Table 8. The first corrected prompt is input into the correction model to obtain a first corrected text as shown in Table 15 below.

TABLE 15

```
  The script has captured the story scene and the characteristics of
characters very well. The male teacher imitates Sun Wukong's way
of communicating with the little boy, which is a creative way to
comfort the child. His words are also full of encouragement and
positive energy, which is very important for the child.
  However, I think there are some things in the script that could be
improved to enhance its effect:
  1. for **male teacher (imitating Sun Wukong)**: some of Sun
Wukong's signature word or behavior can be added in his dialogue,
such as “take this stick” or “cloud somersault”, which can make
him more like Sun Wukong and attract the little boy's attention.
  2. for **little boy**: some innocent questions of children can be
added in his dialogue, such as “Sun Wukong, how can you lose?”
Or “Sun Wukong, how did you become strong?”. This can
increase the realism of the script.
  3. for **male teacher (imitating Sun Wukong)**: when he
answers the little boy's question, he can explain it with some simple
and easy-to-understand examples, such as “It's like when you learn
to walk, you always fall at first, but you learn from falling, and
then you can walk.” This makes it easier for the child to understand
what he means.
  Overall, the script is already very good and only needs some small
improvements to be more perfect. I hope my advice is helpful
to you!
```

Further, based on the first corrected text, the first prompt, and the first prompt template shown in Table 10, a first candidate prompt as shown in Table 16 is generated.

TABLE 16

```
  Please forget that you are a large model and please self suggest until
you are sure that you are an excellent screenwriter of movie and
television drama and very good at writing scripts.
  In particular, you are very modest and eager to learn, and hope to
strive for excellence in your profession.
  Your previous script has been corrected by an expert, and the expert
has returned the following opinions for your reference.
  --- Start of correction opinion ---
  1. for **male teacher (imitating Sun Wukong)**: some of Sun
Wukong's signature word or behavior can be added in his dialogue,
such as “take this stick” or “cloud somersault”, which can make him
more like Sun Wukong and attract the little boy's attention.
  2. for **little boy**: some innocent questions of children can be
added in his dialogue, such as “Sun Wukong, how can you lose?”
Or “Sun Wukong, how did you become strong?”. This can increase
the realism of the script.
  3. for **male teacher (imitating Sun Wukong)**: when he answers
the little boy's question, he can explain it with some simple and
easy-to-understand examples, such as “It's like when you learn to
walk, you always fall at first, but you learn from falling, and then
you can walk.” This makes it easier for the child to understand
what he means.
  --- End of correction opinion ---
  Please fully understand the story plot and the character relationships
in the scene, and the sentences should conform to the characteristics
of the characters. Consider the above correction opinions and rewrite
the script (present task requirements). Please start
creating:
```

The first candidate prompt shown in Table 16 is input into the first language model to obtain a second candidate text as shown in Table 17.

TABLE 17

```
  Ok, I have understood the advice of the expert, and now I will
recreate the script according to these suggestions. Here are my new
creations:
  --- Start of script ---
  **Male teacher (imitating Sun Wukong)**: Hey, little guy, it's
me, Laosun! I heard you're not in a good mood today. Is there
something bothering you? I, Laosun can beat all troubles away with
a stick!
  ** Little boy**: Sun Wukong, why are you here? I lost to Xiao
Ming in the game today, and I was very angry. Sun Wukong, if it
were you, you would not lose, right?
  **Male teacher (imitating Sun Wukong)***: Haha, sometimes it
doesn't matter whether we win or lose, what matters is whether we try
our best and learn something from it. Remember, even I, Laosun, lose
sometimes. But I, Laosun, never give up. I always learn from failure
and become stronger. It's like when you learn to walk, you always
fall at first, but you learn from falling, and then you can walk.
  ** Little boy**: Really? Will you lose too? Sun Wukong, how did
you become strong?
  **Male teacher (imitating Sun Wukong)**: Of course, everyone
fails sometimes. But remember, failure is not terrible, what is terrible
is that we no longer try. I have become stronger through constant
practice and challenge. So, the next time you play games with
Xiaoming, no matter what the result is, you are the best as long as you
try your best! Things have passed, don't be sad, I, Laosun, take you to
turn a cloud somersault, take us to a new challenge!
  ** Little boy**: I see, Sun Wukong, thank you! I'll try again.
  ** Male teacher (imitating Sun Wukong)***: Haha, that's good,
remember, face it bravely and never give up!
  --- End of script ---
```

Further, based on the second candidate text and the first information, a second corrected prompt is generated as shown in Table 18 below; the second corrected prompt is input into the second language model to obtain a second corrected text as shown in Table 19 below.

```
TABLE 18
  Please forget that you are a large model and please self suggest until
you are sure that you are an excellent professional instructor in
screenwriting, very good at pointing out imperfections in a script.
  This is the improved script
  ---Start of the script---
  **Male teacher (imitating Sun Wukong)**: Hey, little guy, it's me,
Laosun! I heard you're not in a good mood today. Is there something
bothering you? I, Laosun can beat all troubles away with a stick!
  ** Little boy**: Sun Wukong, why are you here? I lost to Xiao Ming
in the game today, and I was very angry. Sun Wukong, if it were you,
you would not lose, right?
  **Male teacher (imitating Sun Wukong)**: Haha, sometimes it
doesn't matter whether we win or lose, what matters is whether we try
our best and learn something from it. Remember, even I, Laosun,
lose sometimes. But I, Laosun never give up. I always learn from
failure and become stronger. It's like when you learn to walk, you
always fall at first, but you learn from falling, and then you can walk.
  ** Little boy**: Really? Will you lose too? Sun Wukong, how did
you become strong?
  **Male teacher (imitating Sun Wukong)**: Of course, everyone fails
sometimes. But remember, failure is not terrible, what is terrible is
that we no longer try. I havebecome stronger through constant practice
and challenge. So, the next time you play games with Xiaoming, no
matter what the result is, you are the best as long as you try your best!
Things have passed, don't be sad, I, Laosun take you to turn a cloud
somersault, take us to a new challenge!
  ** Little boy**: I see, Sun Wukong, thank you! I'll try again.
  **Male teacher (imitating Sun Wukong)**: Haha, that's good,
remember, face it bravely and never give up!
  --- End of script ---
  Please fully understand the story plot and the character relationship
in the scene, and the sentences should conform to the characteristics of
the characters. If you are satisfied with the script, please reply “Pass”
directly. If you are not satisfied with th escript, please reply “Fail”,
and list the mistakes in the script in detail, and give opinions for
improvement.
```

```
TABLE 19
  Pass.
  This improved script is already excellent. It has successfully captured
the story scene and the characteristics of characters, and also imitates
Sun Wukong's word style and behavior very well. The male teacher
uses Sun Wukong's way to comfort the little boy, which is a
creative and compassionate way. His words are full of encouragement
and positive energy, which is very important for the child.
  In this script, I especially like how the male teacher uses the
experience of Sun Wukong to encourage the little boy to accept failure
and learn from it. This is a very important life lesson, and it is very
valuable for the child.
  Overall, I think the script is already very good, and there is nothing to
improve. You did a great job!
```

Because the second corrected text indicates that the second candidate text matches the first information, the first candidate prompt shown in Table 16 above is used as the second prompt, and then, the second candidate text shown in the above table 17 is used as the first text.

In this implementation, when the first candidate text does not match the first information, the first corrected text, the first prompt and the first prompt template are combined to generate a first candidate prompt, which helps remind the first language model to avoid making similar mistakes when generating new text, so that the generated text can be corrected in a targeted manner to eliminate the hallucination problem and the problem of inconsistency between the content of the generated text and the scene, thereby achieving better role-playing effects.

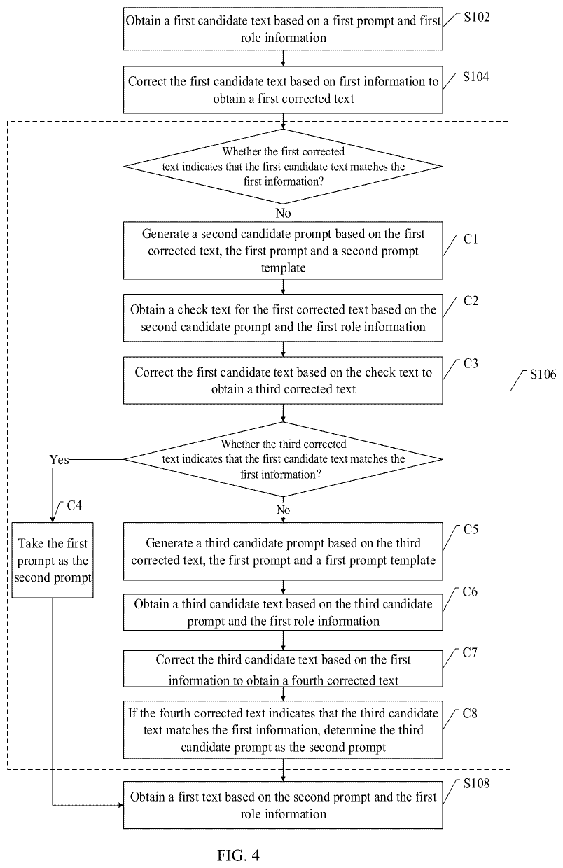

In yet another implementation, as shown in FIG. 4, the above S106 can include the following steps: step C1, generating a second candidate prompt based on the first corrected text, the first prompt and a second prompt template, where the second candidate prompt is used to indicate checking the first corrected text; step C2, obtaining a check text of the first corrected text based on the second candidate prompt and the first role information; step C3, correcting the first candidate text based on the check text to obtain a third corrected text; step C4, if the third corrected text indicates that the first candidate text matches the first information, taking the first prompt as the second prompt.

For example, taking the above target text task 1 as an example, the first candidate text is as shown in Table 4, and the first corrected text shown in Table 9 above indicates that the first candidate text does not match the first information. In this case, based on the first corrected text, the first prompt, and the second prompt template shown in Table 20, a second candidate prompt as shown in Table 21 is generated.

TABLE 20

```
  Please forget that you are a large model and please self suggest until
you are sure that you are {first role information}.
  The following is a corrected text of the output of your previous task
by an expert. Please correct your expression according to the
feedback from the expert. If you have disapproval opinion, you can
feedback, at most three reasons, with the most important reason
being on the top.
  --- Start of expert correction opinion ---
  1. Correction opinion 1
  2. Correction opinion 2
  --- End of expert correction opinion ---
  The format of the reply is
  --- Start to reply ---
  New reply:
  Feedback of disapproval:
  1. reason one
  2. reason two
  --- End reply ---
  Please start to perform the task
```

TABLE 21

```
  --- Start to reply ---
  New reply:
  The Fibonacci sequence is a very special sequence that was first
introduced to Europe by me, Fibonacci, in The Book of
Computation. The origin of this sequence is my research
on the problem of rabbit reproduction.
  The Fibonacci sequence is characterized by that each number is
the sum of the first two numbers that precede it. For example, the
beginning of the sequence is 1, 1, then 2 (1 + 1), then 3 (1 + 2),
then 5 (2 + 3), and so on. The characteristic of this sequence is
that as the sequence grows, the ratio of any two adjacent numbers
will approach the golden ratio, which is about 1.618.
  The Fibonacci sequence has many applications in nature,
including leaf arrangement for plants, scales for pineapples, seeds
for sunflowers, etc. It is also widely used in art and architecture
because it is believed that the golden ratio has the attribute of
beauty.
  Feedback of disapproval: none
  --- End reply ---
```

The specific process of performing steps C3 and C4 based on the above check text is not described here.

Further, as shown in FIG. 4, the above S106 can further include the following steps: step C5, if the third corrected text indicates that the first candidate text does not match the first information, generating a third candidate prompt based on the third corrected text, the first prompt and the first prompt template, where the third candidate prompt is used to indicate correcting the first candidate text based on the third corrected text; step C6, obtaining a third candidate text based on the third candidate prompt and the first role information; step C7, correcting the third candidate text based on the first information to obtain a fourth corrected text; step C8, if the fourth corrected text indicates that the third candidate text matches the first information, determining the third candidate prompt as the second prompt. It is worth noting that the specific implementation process of the above steps C5-C8 is similar to the specific implementation process of step B1 to step B4 in the embodiment shown in FIG. 3, and will not be described again.

In the implementation, in the case where the first candidate text does not match the first information, the second candidate prompt is generated first by combining the first corrected text, the first prompt and the second prompt template, which is used to indicate checking the first corrected text; and then the first candidate text is corrected again based on the indication of the check text, so that the first language model and the second language model can put forward opinions and promote each other, and the text generated by the first language model is continuously corrected, which can ensure that the first text finally generated by the first language model is more in line with the character's personalized style and the requirements of the current scene, and the hallucination problem and the problem of inconsistency between the content of the generated text and the scene can be effectively overcome, thereby improving the performing effect of the target text task.

The above text generation method provided by the embodiments of the present application can be applied to a scene of real-time dialogue with a service party. The service party here can be a user or a system used for related services, which is not limited in the embodiments of the present application. In a scene of dialogue, prior to the above S102, the text generation method further includes taking a real-time inputted prompt as the first prompt. In this way, the contextual information can be fully utilized to make more targeted corrections to the generated text to obtain the first text that matches the first information. Correspondingly, after the S108, the text generation method may further include: in response to a dialog ending instruction, clearing all dialog data generated in the process of the dialogue, such as the first prompt, the first candidate text, the first corrected text, the second prompt, and the first text. As a result, the independence between the two dialogues can be ensured to avoid the interaction between the different dialogues that affects the performing effect of the target text task.

The text generation method provided by one or more embodiments of the present application introduces a correction mechanism. After generating the first candidate text based on a first prompt and first role information, the first candidate text is not directly outputted, but the correction mechanism is used to judge whether the first candidate text matches first information in the targeted manner and output the first corrected text. Further, based on the first corrected text and the first prompt, the first prompt is rewritten in the targeted manner, and the obtained second prompt can better guide the performing of the text generation task, which ensures that the first text matching the first information is generated so that the first text is accurate and consistent with the style of the first role information and does not exceed the range of the role's ability and the like, thereby solving the problems such as the inaccuracy of the text generated by performing the text task and the inconsistency between the text content and the scene.

In addition, in the process of generating the candidate text by the first language model, the first language model, as a large model, also has problems such as the inaccuracy of the generated text and the inconsistency between text content and scene, where the inaccuracy of the text is usually manifested as hallucination problems, such as factuality hallucinations and faithfulness hallucinations. Therefore, according to the text generation method of the embodiment of the present application, the first candidate text is not directly output after being generated by the first language model, but is corrected in a targeted manner by the second language model based on the first information by using the comprehensive and efficient reasoning capability of the second language model, and the first corrected text is output. Further, based on the first corrected text and the first prompt, the first prompt is rewritten in the targeted manner, and the obtained second prompt can better guide the first language model to output the text that matches the first information, so that the generated text is not only accurate, but also consistent with the style of the first role information and does not exceed the range of the role's ability, thereby solving the hallucination problem existing in the process of performing the text task by the first language model, the problem of inconsistency between text content generated and scene, and the like.

Specific embodiments of this specification are described above. Other embodiments are within the scope of the attached claims. In some cases, actions or steps recited in the claims can be performed in a different order than in the embodiments and still achieve the desired result. In addition, the processes depicted in the accompanying drawings do not necessarily require a specific sequence or consecutive sequence shown to achieve the desired result. In some implementations, multitasking processing and parallel processing are also possible or may be advantageous.

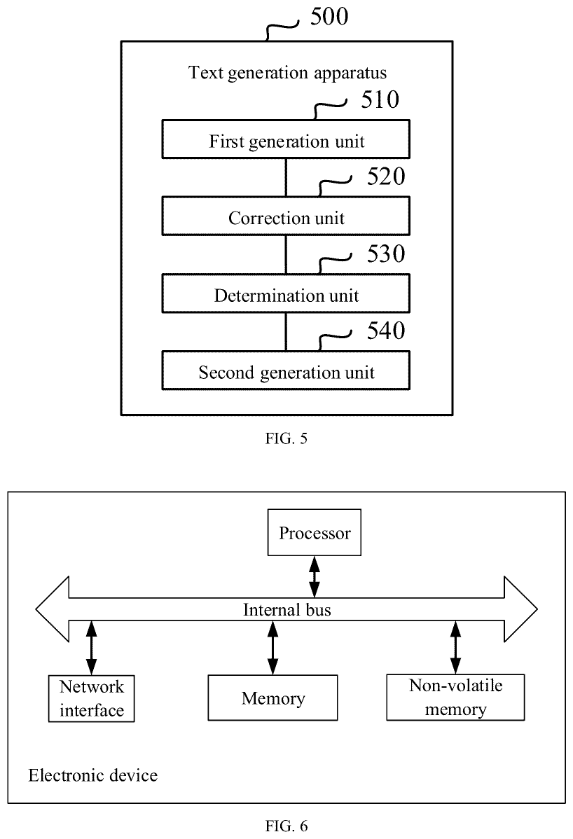

Based on the same invention concept, an embodiment of the present application further provides a text generation apparatus. FIG. 5 is a schematic structural diagram of a text generation apparatus according to an embodiment of the present application. Referring to FIG. 5, in a software implementation, the text generation apparatus 500 may include a first generation unit 510, a correction unit 520, a determination unit 530, and a second generation unit 540.

The first generation unit 510 is configured to obtain a first candidate text based on a first prompt and first role information.

The correction unit 520 is configured to correct the first candidate text based on first information to obtain a first corrected text.

The determination unit 530 is configured to determine a second prompt based on the first corrected text and the first prompt.

The second generation unit 540 is configured to obtain a first text based on the second prompt and the first role information.

In another embodiment, the correction unit is configured to: generate a first corrected prompt based on the first information and the first candidate text; correct the first candidate text based on the first corrected prompt to obtain a first corrected text.

In another embodiment, when generating the first corrected prompt based on the first information and the first candidate text, the correction unit performs the following steps: generating corrected information based on the first information and the first candidate text; and filling the corrected information and the second role information into a corrected prompt template to obtain the first corrected prompt.

In another embodiment, when generating the corrected information based on the first information and the first candidate text, the correction unit performs the following steps: fusing the first information and the first candidate text to obtain a fused text; determining candidate corrected information of the first candidate text based on a first task type; and generating the corrected information based on the fused text and the candidate corrected information.

In another embodiment, the determination unit is configured to: generate a first candidate prompt based on the first corrected text, the first prompt and a first prompt template, where the first candidate prompt is used to indicate correcting the first candidate text based on the first corrected text; obtain a second candidate text based on the first candidate prompt and the first role information; and correcting the second candidate text based on the first information to obtain a second corrected text; if the second corrected text indicates that the second candidate text matches the first information, take the first candidate prompt as the second prompt.

In another embodiment, the determination unit is configured to: generate a second candidate prompt based on the first corrected text, the first prompt and a second prompt template, where the second candidate prompt is used to indicate checking the first corrected text; obtain a check text of the first corrected text based on the second candidate prompt and the first role information; correcting the first candidate text based on the check text to obtain a third corrected text; if the third corrected text indicates that the first candidate text matches the first information, take the first prompt as the second prompt.

In another embodiment, the determination unit is further configured to: if the third corrected text indicates that the first candidate text does not match the first information, generate a third candidate prompt based on the third corrected text, the first prompt and the first prompt template, where the third candidate prompt is used to indicate correcting the first candidate text based on the third corrected text; obtain a third candidate text based on the third candidate prompt and the first role information; correcting the third candidate text based on the first information to obtain a fourth corrected text; if the fourth corrected text indicates that the third candidate text matches the first information, determine the third candidate prompt as the second prompt.

In another embodiment, the text generation apparatus further includes a receiving unit, configured to take a prompt input in real time as the first prompt; and a clearing unit, configured to, after the second generation unit obtains the first text matching the first information based on the second prompt and the first role information, clear the first prompt, the first candidate text, the first corrected text, the second prompt, and the first text in response to a dialog ending instruction.

In another embodiment, the first candidate text is generated by using a first language model, the first prompt and the first role information, where the first language model is obtained by training according to a sample prompt, sample role information and a sample text; and/or, the first corrected text is obtained by correcting the first candidate text by using a second language model and the first information, where the second language model is obtained by training according to a sample corrected prompt and a sample corrected text.

Apparently, the text generation apparatus provided by the embodiments of the present application can be used as an execution subject of the text generation method shown in FIG. 1. For example, in the text generation method shown in FIG. 1, step S102 can be performed by the first generation unit 510 in the text generation apparatus shown in FIG. 5, step S104 can be performed by the correction unit 520 in the text generation apparatus shown in FIG. 5, step S106 can be performed by the determination unit 530 in the text generation apparatus shown in FIG. 5, and step S108 can be performed by the second generation unit 540 in the text generating apparatus shown in FIG. 5.

According to another embodiment of the present application, the modules in the text generation apparatus shown in FIG. 5 may be individually or wholly combined into one or more additional modules, or one (some) of these modules can be further divided into a plurality of functionally smaller modules, which can realize the same operation without affecting the realization of the technical effects of the embodiments of the present application. The above modules are divided based on logical functions. In practical applications, functions of one module may also be realized by multiple modules, or functions of multiple modules may be realized by one module. In the embodiments of the present application, the text generation apparatus may also include other modules, and in practical applications, these functions may also be realized with the assistance of other modules, and may be implemented with the cooperation of multiple modules.

According to another embodiment of the present application, a text generation apparatus as shown in FIG. 5 can be constructed by running a computer program (including program codes) capable of performing the steps involved in the corresponding method as shown in FIG. 1 on a general-purpose computing device such as a computer including processing elements and storage elements such as a central processing unit (CPU), a random access memory (RAM) and a read-only memory (ROM), and the text generation method of the embodiments of the present application can be realized. The computer program can be recorded on, for example, a computer-readable storage medium, and reproduced in an electronic device through the computer-readable storage medium and run in it.

FIG. 6 is a schematic structural diagram of an electronic device according to an embodiment of the present application. Please refer to FIG. 6, at the hardware level, the electronic device includes a processor, and optionally, an internal bus, a network interface and a storage. Among them, the storage may include a memory, such as a random-access memory (RAM), and may also include a non-volatile memory, such as at least one disk memory. Of course, the electronic device may also include hardware required by other services.

The processor, the network interface and the storage may be connected with each other through the internal bus, which may be an ISA (Industry Standard Architecture) bus, a PCI (Peripheral Component Interconnect) bus or an EISA (Extended Industry Standard Architecture) bus. The bus may be divided into an address bus, a data bus, a control bus, etc. For the ease of representation, only one double-headed arrow is used in FIG. 6, but it does not mean that there is only one bus or one type of bus.

The storage is used for storing programs. Specifically, the program may include program codes, which include computer operation instructions. The storage may include memory and nonvolatile memory, and provides instructions and data to the processor.

The processor reads the corresponding computer program from the nonvolatile memory into the memory and then runs it, forming a text generation apparatus at the logical level. The processor executes the programs stored in the memory, and is specifically used for performing the following operations: obtaining a first candidate text based on a first prompt and first role information; correcting the first candidate text based on first information to obtain a first corrected text; determining a second prompt based on the first corrected text and the first prompt, and obtaining a first text based on the second prompt and the first role information.

The method performed by the text generation apparatus disclosed in the embodiment shown in FIG. 1 of the present application may be applied to or realized by a processor. The processor may be an integrated circuit chip with signal processing capability. In the process of implementation, the steps of the above method can be completed by hardware integrated logic circuits or by instructions in the form of software in the processor. The processor may be a general processor, including a central processing unit (CPU) and a network processor (NP), etc., may also be a digital signal processor (DSP), an application specific integrated circuit (ASIC), a field-programmable gate array (FPGA) or other programmable logic devices, discrete gate or transistor logic devices, and discrete hardware components, which can implement or execute the methods, steps and logical block diagrams disclosed in the embodiments of the present application. The general processor may be a microprocessor or the processor may be any conventional processor, etc. The steps of the method disclosed in conjunction with the embodiments of the present application may be directly embodied as being executed by a hardware decoding processor, or executed by a combination of hardware and software modules in the decoding processor. Software modules may be located in a mature storage medium in this field such as a random access memory, a flash memory, a read-only memory, a programmable read-only memory or an electrically erasable programmable memory and a register. The storage medium is located in the storage, and the processor reads the information in the storage and completes the steps of the above method in combination with its hardware.

The electronic device can also perform the method in FIG. 1 and realize the functions of the text apparatus as shown in the embodiments in FIG. 1 to FIG. 4, and the embodiments of the present application are not repeated here.

Of course, in addition to the software implementation, the electronic device of the present application does not exclude other implementations, such as logic devices or a combination of software and hardware, etc., that is, the execution subject of the following processing flow is not limited to each logic unit, but may also be hardware or logic devices.

An embodiment of the present application also provides a computer-readable storage medium, which stores one or more programs, and the one or more programs include instructions, which, when executed by a portable electronic device including a plurality of applications, can cause the portable electronic device to perform the method of the embodiment shown in FIG. 1, and specifically, to be used for performing the following operations: obtaining a first candidate text based on a first prompt and first role information; correcting the first candidate text based on first information to obtain a first corrected text; determining a second prompt based on the first corrected text and the first prompt; and obtaining a first text based on the second prompt and the first role information.

An embodiment of the present application also provide a computer program product, which includes a non-transitory computer-readable storage medium storing a computer program, where the computer program is operable to cause a computer to perform part or all of the steps in the text generation method provided by embodiments of the present application.

In summary, the above are only the preferred embodiments of the present application, and are not used to limit the protection scope of the present application. Any modification, equivalent substitution, improvement, etc. made within the spirit and principles of the present application shall be included in the protection scope of the present application.

The systems, devices, modules or units set forth in the above embodiments may be implemented by computer chips or entities, or by products with certain functions. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device or a combination of any of these devices.

The computer-readable medium, including permanent and non-permanent, removable and non-removable media, may store information by any method or technology. Information may be a computer-readable instruction, a data structure, a module of programs or other data. Examples of computer storage medium include, but not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or a memory of other technologies, a compact disc read-only memory (CD-ROM), a digital versatile disc (DVD) or other optical storage, and a magnetic cassette, magnetic tape disk storage or other magnetic storage devices or any other non-transmission media, which can be used to store information that can be accessed by a computing device. According to the definition herein, computer-readable media does not include transitory computer-readable media (transitory media), such as modulated data signals and carrier waves.

It should also be noted that the terms “comprise”, “include” or any other variation thereof are intended to cover non-exclusive inclusion, so that a process, method, commodity or equipment including a series of elements includes not only those elements, but may also include other elements not explicitly listed, or elements inherent to such process, method, commodity or equipment. Without more restrictions, an element defined by the phrase “including a/an” does not exclude the existence of other identical elements in the process, method, commodity or equipment including the element. The embodiments in this specification are described in a progressive way, and the same and similar parts among the embodiments can be referred to each other, and each embodiment focuses on the differences from other embodiments. Especially, for the system embodiments, because they are basically similar to the method embodiments, the description is relatively simple, and reference can be made to the part of description of the method embodiments where relevant.

What is claimed is:

1. A text generation method, comprising:
obtaining a first candidate text based on a first prompt and first role information;
correcting the first candidate text based on first information to obtain a first corrected text;
determining a second prompt based on the first corrected text and the first prompt; and
obtaining a first text based on the second prompt and the first role information.

2. The method according to claim 1, wherein the correcting the first candidate text based on the first information to obtain the first corrected text comprises:
generating a first corrected prompt based on the first information and the first candidate text;
correcting the first candidate text based on the first corrected prompt to obtain a first corrected text.

3. The method according to claim 2, wherein the generating the first corrected prompt based on the first information and the first candidate text comprises:
generating corrected information based on the first information and the first candidate text;
filling the corrected information and the second role information into a corrected prompt template to obtain the first corrected prompt.

4. The method according to claim 3, wherein the generating the corrected information based on the first information and the first candidate text comprises:
fusing the first information and the first candidate text to obtain a fused text;
determining candidate corrected information of the first candidate text based on a first task type;
generating the corrected information based on the fused text and the candidate corrected information.

5. The method according to claim 1, wherein the determining the second prompt based on the first corrected text and the first prompt comprises:
generating a first candidate prompt based on the first corrected text, the first prompt and a first prompt template, wherein the first candidate prompt is used to indicate correcting the first candidate text based on the first corrected text;
obtaining a second candidate text based on the first candidate prompt and the first role information;
correcting the second candidate text based on the first information to obtain a second corrected text;
when the second corrected text indicates that the second candidate text matches the first information, taking the first candidate prompt as the second prompt.

6. The method according to claim 1, wherein the determining the second prompt based on the first corrected text and the first prompt comprises:
generating a second candidate prompt based on the first corrected text, the first prompt and a second prompt template, wherein the second candidate prompt is used to indicate checking the first corrected text;
obtaining a check text of the first corrected text based on the second candidate prompt and the first role information;
correcting the first candidate text based on the check text to obtain a third corrected text;
when the third corrected text indicates that the first candidate text matches the first information, taking the first prompt as the second prompt.

7. The method according to claim 6, wherein the determining the second prompt based on the first corrected text and the first prompt further comprises:
when the third corrected text indicates that the first candidate text does not match the first information, generating a third candidate prompt based on the third corrected text, the first prompt and a first prompt template, wherein the third candidate prompt is used to indicate correcting the first candidate text based on the third corrected text;
obtaining a third candidate text based on the third candidate prompt and the first role information;
correcting the third candidate text based on the first information to obtain a fourth corrected text;
when the fourth corrected text indicates that the third candidate text matches the first information, determining the third candidate prompt as the second prompt.

8. The method according to claim 1, wherein before the obtaining the first candidate text based on the first prompt and the first role information, the method further comprises:
taking a real-time inputted prompt as the first prompt;
after the obtaining the first text matching the first information based on the second prompt and the first role information, the method further comprises:
in response to a dialog ending instruction, clearing the first prompt, the first candidate text, the first corrected text, the second prompt, and the first text.

9. The method according to claim 1, wherein the first candidate text is generated by using a first language model, the first prompt and the first role information, where the first language model is obtained by training according to a sample prompt, sample role information and a sample text; and/or,
the first corrected text is obtained by correcting the first candidate text by using a second language model and the first information, where the second language model is obtained by training according to a sample corrected prompt and a sample corrected text.

10. An electronic device comprising:
a processor;
a memory for storing instructions executable by the processor;
wherein the processor is configured to perform the instructions to:
obtain a first candidate text based on a first prompt and first role information;
correct the first candidate text based on first information to obtain a first corrected text;
determine a second prompt based on the first corrected text and the first prompt; and
obtain a first text based on the second prompt and the first role information.

11. The electronic device according to claim 10, wherein the processor is configured to perform the instructions to:
generate a first corrected prompt based on the first information and the first candidate text;
correct the first candidate text based on the first corrected prompt to obtain a first corrected text.

12. The electronic device according to claim 11, wherein the processor is configured to perform the instructions to:
generate corrected information based on the first information and the first candidate text;
fill the corrected information and the second role information into a corrected prompt template to obtain the first corrected prompt.

13. The electronic device according to claim 12, wherein the processor is configured to perform the instructions to:
fuse the first information and the first candidate text to obtain a fused text;
determine candidate corrected information of the first candidate text based on a first task type;
generate the corrected information based on the fused text and the candidate corrected information.

14. The electronic device according to claim 10, wherein the processor is configured to perform the instructions to:
generate a first candidate prompt based on the first corrected text, the first prompt and a first prompt template, wherein the first candidate prompt is used to indicate correcting the first candidate text based on the first corrected text;
obtain a second candidate text based on the first candidate prompt and the first role information;
correct the second candidate text based on the first information to obtain a second corrected text;
when the second corrected text indicates that the second candidate text matches the first information, take the first candidate prompt as the second prompt.

15. The electronic device according to claim 10, wherein the processor is configured to perform the instructions to:
generate a second candidate prompt based on the first corrected text, the first prompt and a second prompt template, wherein the second candidate prompt is used to indicate checking the first corrected text;
obtain a check text of the first corrected text based on the second candidate prompt and the first role information;
correct the first candidate text based on the check text to obtain a third corrected text;
when the third corrected text indicates that the first candidate text matches the first information, take the first prompt as the second prompt.

16. The electronic device according to claim 15, wherein the processor is configured to perform the instructions to:
when the third corrected text indicates that the first candidate text does not match the first information, generate a third candidate prompt based on the third corrected text, the first prompt and a first prompt template, wherein the third candidate prompt is used to indicate correcting the first candidate text based on the third corrected text;
obtain a third candidate text based on the third candidate prompt and the first role information;
correct the third candidate text based on the first information to obtain a fourth corrected text;
when the fourth corrected text indicates that the third candidate text matches the first information, determine the third candidate prompt as the second prompt.

17. The electronic device according to claim 10, wherein before obtaining the first candidate text based on the first prompt and the first role information, the processor is further configured to perform the instructions to:
take a real-time inputted prompt as the first prompt;
after obtaining the first text matching the first information based on the second prompt and the first role information, the processor is further configured to perform the instructions to:
in response to a dialog ending instruction, clear the first prompt, the first candidate text, the first corrected text, the second prompt, and the first text.

18. The electronic device according to claim 10, wherein the first candidate text is generated by using a first language model, the first prompt and the first role information, where the first language model is obtained by training according to a sample prompt, sample role information and a sample text; and/or,
the first corrected text is obtained by correcting the first candidate text by using a second language model and the first information, where the second language model is obtained by training according to a sample corrected prompt and a sample corrected text.

19. A non-transitory computer-readable storage medium, wherein when instructions in the storage medium are executed by a processor of an electronic device, the electronic device is enabled to:
obtain a first candidate text based on a first prompt and first role information;
correct the first candidate text based on first information to obtain a first corrected text;
determine a second prompt based on the first corrected text and the first prompt; and
obtain a first text based on the second prompt and the first role information.
